(19) United States
(12) Patent Application Publication
(10) Pub. No.: US 2008/0165093 A1
(43) Pub. Date: Jul. 10, 2008

(54) PLASMA DISPLAY PANEL AND METHOD OF DRIVING THE SAME

(76) Inventors: Tae-seung Cho, Suwon-si (KR); Jae-ik Kwon, Suwon-si (KR); Young-do Choi, Suwon-si (KR)

Correspondence Address: CHRISTIE, PARKER & HALE, LLP, PO BOX 7068, PASADENA, CA, 91109-7068, US

(21) Appl. No.: 11/961,954

(22) Filed: Dec. 20, 2007

(30) Foreign Application Priority Data
Dec. 27, 2006 (KR) 10-2006-0135096

(51) Int. Cl. G09G 3/28

(52) U.S. Cl. 345/71; 345/60

(57) ABSTRACT

An alternating current type plasma display panel with electrodes of asymmetrical construction and a method for driving the same. A first pulse is applied to the first electrode. A second pulse is applied to the second electrode, the second pulse having a width and a phase different from those of the first pulse. The pulse widths are adjusted according to a size of the electrodes to make an amount of a wall charge in two electrodes substantially uniform, thereby making the intensity and an amount of the light uniform.

### CROSS-REFERENCE TO RELATED APPLICATION

This application claims priority to and the benefit of Korean Patent Application No. 10-2006-0135096, filed on Dec. 27, 2006, in the Korean Intellectual Property Office, the entire content of which is incorporated herein by reference.

### BACKGROUND

1. Field of the Invention

The present invention relates to a plasma display panel (referred to as ‘PDP’ hereinafter) and a method of driving the same, and more particularly to an alternating current type plasma display panel.

2. Discussion of Related Art

Recently, following a demand for large flat panel displays, a PDP has been available where the fabrication of large-scale panels is feasible.

A PDP displays characters or images with the emission of light from a fluorescent material using plasma generated by a glow discharge between a pair of electrodes. In comparison with a liquid crystal display (LCD) or a field emission display (FED), the PDP has higher luminance and emission efficiency. However, since the PDP has lower emission efficiency than a cathode ray tube (CRT) display device, research to improve the emission efficiency of PDPs continues.

Generally, in a PDP, pixels are arranged in a matrix pattern, with each pixel located where a row of sustain electrodes crosses a column of address electrodes. A pixel is selected when, based on image data, an address electrode creates a weak discharge in the pixel cell. Once selected, this discharge can be sustained by providing suitable voltages on sustain electrodes. A fluorescent material within the pixel cell is excited by ultraviolet rays generated during the sustain discharge procedure and emits visible light. In this case, the number of sustain discharges is adjusted to express a gray level to display an image. Accordingly, the number of sustain discharges is an important factor to determine emission luminance and emission efficiency of a plasma display panel.

On the other hand, the structure of the pixels is another main factor for emission luminance and emission efficiency of the PDP. The structure of the pixel can be classified into direct current (DC) or alternating current (AC) types. Recently, AC 3-electrode surface discharge structures are commonly used. Because there is a limit to how much the size of an AC 3-electrode surface discharge structure can be adjusted, it has a disadvantage of reduced emission efficiency.

### SUMMARY OF THE INVENTION

Accordingly, a feature of an embodiment of the present invention is a plasma display panel and a method of driving the same with improved emission efficiency.

Another aspect according to an embodiment of the present invention is a plasma display panel and a method of driving the same with a substantially uniform amount of wall charges on two electrodes.

Another aspect according to an embodiment of the present invention is a plasma display panel having asymmetric sustain electrodes and a method of driving the same.

The foregoing and/or other aspects of the present invention are achieved by providing a plasma display panel including a first substrate and a second substrate that face each other. Between the substrates, a plurality of first electrodes are connected to each other in a first direction by a first electrode line. The first electrodes have discharge holes at their central regions. A dielectric encloses the first electrode and the first electrode line, and connects the plurality of first electrodes to one another in a second direction. A plurality of second electrodes is on the second substrate, and corresponds to the discharge holes in the first electrode. The second electrodes are connected to each other in the second direction by a second electrode line. A fluorescent layer is on the first substrate, and is exposed through the discharge holes.

According to another aspect of the present invention, a method for driving an AC type plasma display panel includes a first electrode and a second electrode of an asymmetrical construction. First, a first pulse is applied to the first electrode. Second, a second pulse is applied to the second electrode, the second pulse having a width and a phase different from those of the first pulse.

### BRIEF DESCRIPTION OF THE DRAWINGS

These and/or other embodiments and features of the invention will become apparent and more readily appreciated from the following description of the certain exemplary embodiments, taken in conjunction with the accompanying drawings of which:

FIG. 1 is a cross-sectional view illustrating one cell of a plasma display panel according to a first embodiment of the present invention;

FIGS. 2A and 2B are schematic plan views illustrating an electrode shown in FIG. 1;

FIGS. 3A and 3B are schematic plan views illustrating a first electrode shown in FIG. 1;

FIG. 4 is a cross-sectional view illustrating one cell of a plasma display panel according to a second embodiment of the present invention;

FIGS. 5A and 5B are schematic plan views showing an electrode shown in FIG. 4;

FIG. 6A is a schematic plan view illustrating a first electrode shown in FIG. 4;

FIG. 6B is a schematic plan view illustrating a second electrode shown in FIG. 4;

FIG. 7 is a waveform diagram illustrating the operation of a plasma display panel according to an embodiment of the present invention;

FIG. 8 is a graph showing relative intensity of infra-red radiation from a cell corresponding to the waveforms of FIG. 7; and

FIGS. 9 and 10 are waveform diagrams illustrating the operation of a plasma display panel according to another embodiment of the present invention.

### DETAILED DESCRIPTION OF EXEMPLARY EMBODIMENTS

Hereinafter, certain exemplary embodiments according to the present invention will be described with reference to the accompanying drawings. Here, when a first element is described as being connected or coupled to a second element, the first element may not only be directly connected or coupled to the second element but may also be indirectly connected or coupled to the second element via a third element. Further, some of the elements that are not essential to the complete understanding of the invention are omitted for clarity. Also, like reference numerals refer to like elements throughout.

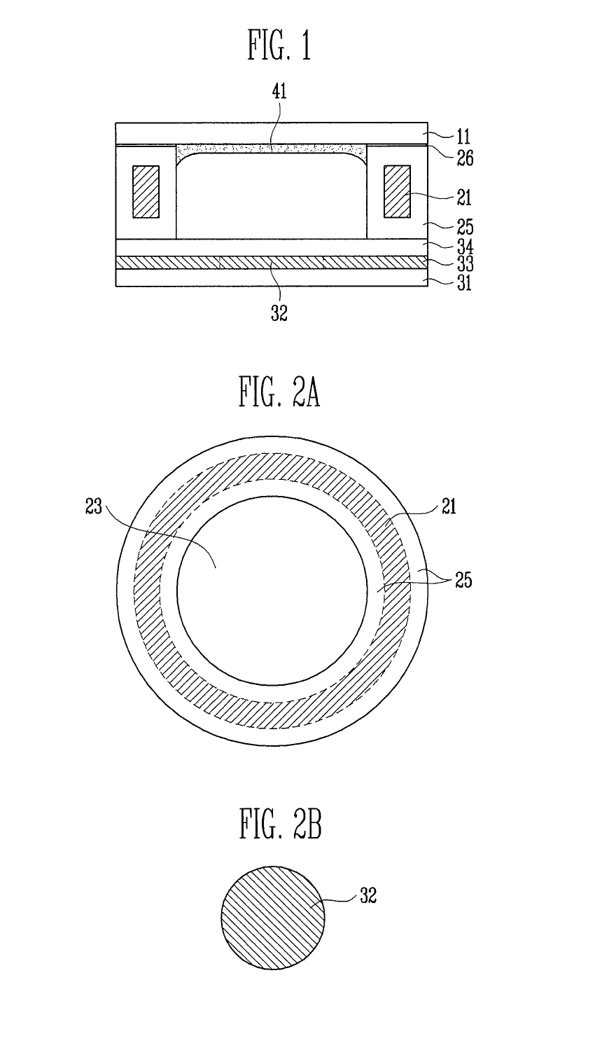

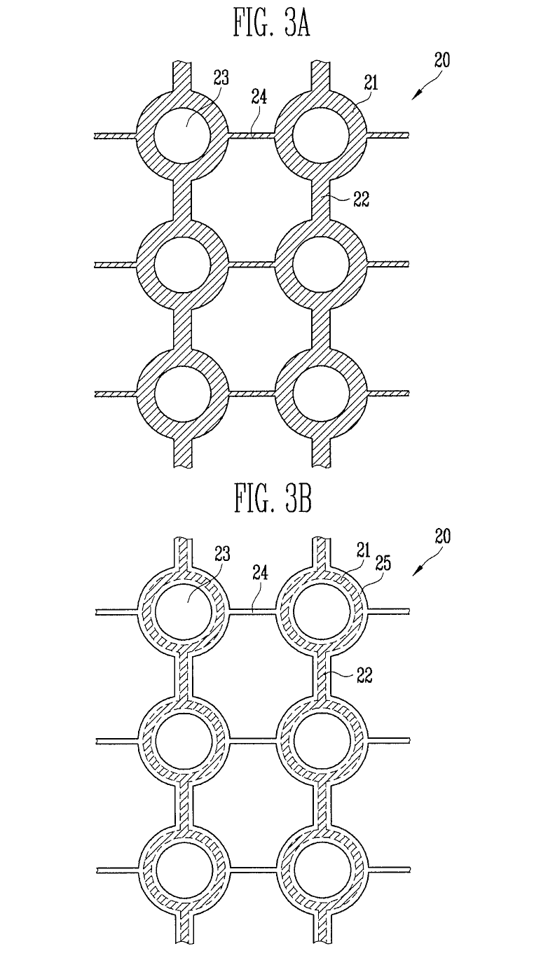

FIG. 1 is a cross-sectional view illustrating a plasma display panel according to a first exemplary embodiment of the present invention, showing one pixel. FIG. 2A and FIG. 2B are schematic plan views showing an electrode shown in FIG. 1.

With reference to FIGS. 1 and 2A, a plurality of first sustain electrodes 21 are arranged at intervals (e.g., predetermined intervals) between an upper substrate 11 and a lower substrate 31. The upper substrate 11 and the lower substrate 31 are arranged to face each other. The first electrode 21 has a thickness that may be predetermined. Each of the first electrodes 21 has an annular shape (e.g., a ring shape) with a round discharge hole 23 formed at a central region thereof. The first electrodes 21 are arranged in one direction and are coupled to each other by first electrode lines 22, shown, for example, in FIG. 3B. A dielectric 25 encloses the plurality of first electrodes 21 and the first electrode lines 22. The first electrodes 21 arranged in another direction are connected to each other by bridges 24 (see FIG. 3A), which are formed of the dielectric 25.

With reference to FIGS. 1 and 2B, a plurality of second sustain electrodes 32 are arranged at intervals (e.g., predetermined intervals) on the lower substrate 31 corresponding to discharge holes 23 of the first electrodes 21. The second electrode 32 has a disk form, and has a thickness that may be predetermined. The second electrodes 32 arranged in one direction are connected to each other by the second electrode lines 33, which cross the first electrode lines 22. A dielectric 34 encloses the plurality of second electrodes 32 and second electrode lines 33.

A fluorescent layer 41 is formed on the upper substrate 11, which is exposed through the discharge hole 23. Inert mixing gases such as He+Xe, Ne+Xe, or He+Xe+Ne are implanted in a closed discharge space in the discharge hole 23 as gas for forming plasma.

FIG. 3A and FIG. 3B are plan views for illustrating the first electrode 21 and the first electrode line 22 of the plasma display panel according to a first embodiment of the present invention in more detail, which can be provided by a metal sheet 20 having a thickness (e.g., a predetermined thickness), formed for example of aluminum (Al).

For example, as shown in FIG. 3A, a metal sheet 20 is patterned through photolithography and etch processes to create the plurality of first electrodes 21 with a suitable arrangement and having discharge holes 23 at central regions thereof, the first electrode lines 22 connecting the first electrodes 21 arranged in a first direction, and bridges 24 connecting the first electrodes 21 arranged in a second direction.

The metal sheet 20 patterned as shown in FIG. 3A is oxidized, forming a dielectric 25 of a metal oxide on surfaces of the first electrodes 21 and the first electrode lines 22 as shown in FIG. 3B. At this time, by making widths of the first electrodes 21 and the first electrode lines 22 wider than a width of the bridges 24, and by performing an oxidizing process, when the dielectric 25 is formed, the bridges 24 are completely changed to an oxide. Here, the dielectric 25 is an oxide of the first electrode 21. Accordingly, after the bridges 24 are changed to the oxide, the first electrodes 21 connected in the second direction by the bridges 24 are structurally connected to each other, but can be electrically isolated.

The first electrodes 21 and the first electrode lines 22 formed as above from a metal sheet 20 can be adhered to the upper substrate 11 by an adhesive 26.

The embodiment above described the first electrodes 21 and the second electrodes 32 having an asymmetric construction and a circular shape. However, the present invention is not limited thereto. It can be embodied in various forms. For example, the first electrode 21 and the second electrode 32 can have a polygonal structure with a discharge hole with a circular or a tetragonal shape at a central region of a tetragonal electrode. In a further embodiment, the dielectric 25 formed on a sidewall of the first electrode 21 can be used as a partition for isolating a pixel. Otherwise, a separate partition can be formed.

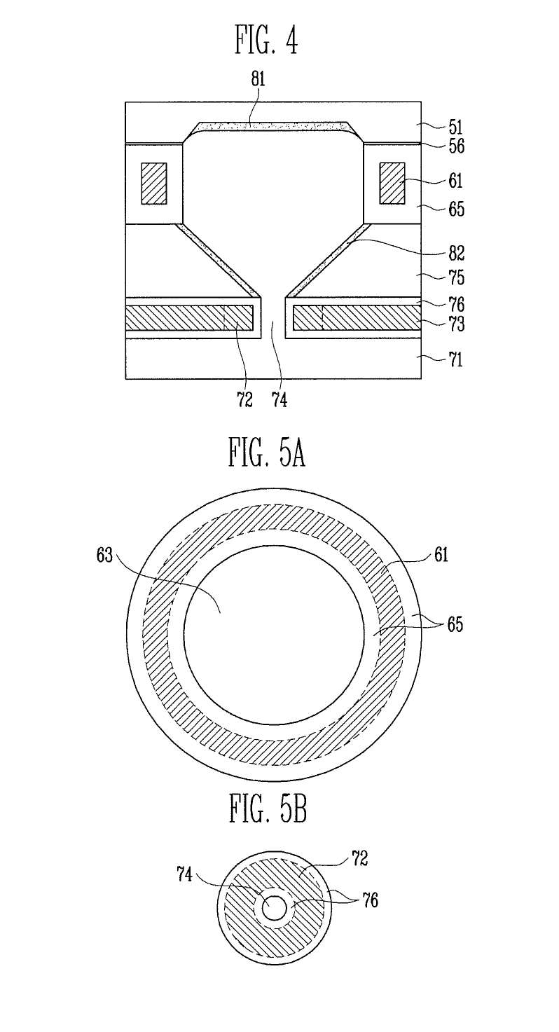

FIG. 4 is a cross-sectional view illustrating a plasma display panel according to a second exemplary embodiment of the present invention, which schematically shows one pixel. FIG. 5A and FIG. 5B are a schematic plan view showing an electrode shown in FIG. 4.

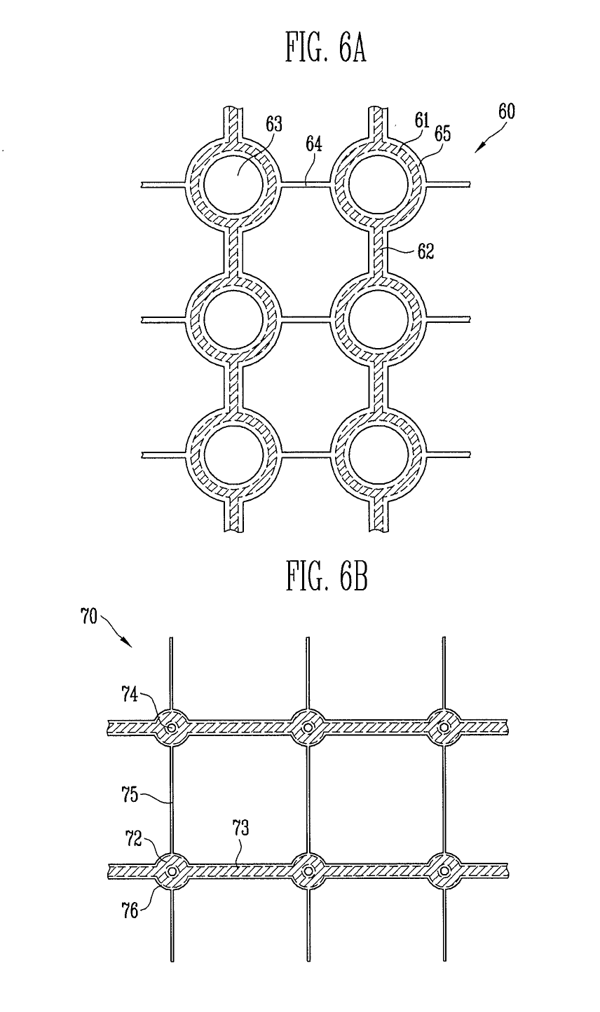

With reference to FIG. 4 and FIG. 5A, a plurality of first electrodes 61 are arranged at intervals (e.g., predetermined intervals) between an upper substrate 51 and a lower substrate 71, which are arranged to face each other. Each of the first electrodes 61 has an annular shape (e.g., a ring shape) with a round discharge hole 63 at a central region thereof. The first electrodes 61 are arranged in one direction and are coupled to each other by first electrode lines 62, shown, for example, in FIG. 6A. A dielectric 65 encloses the plurality of first electrodes 61 and the first electrode lines 62. The first electrodes 61 arranged in another direction are connected to each other by a bridge 64, which is formed of the dielectric 65.

With reference to FIGS. 4 and 5B, a plurality of second electrodes 72 are arranged at intervals (e.g., predetermined intervals) on the lower substrate 71 corresponding to discharge holes 63 of the first electrodes 61. The second electrodes 72 have an annular shape (e.g., a ring shape) with round discharge holes 74 at central regions thereof. The second electrodes 72 arranged in one direction are connected to each other by the second electrode lines 73, which cross the first electrode lines 62. A dielectric 76 encloses the plurality of second electrodes 72 and second electrode lines 73.

Furthermore, a spacer layer 75 is formed between the first electrode 61 and the second electrode 72, with a hole formed at a part of the spacer layer 75 corresponding to the discharge hole 63. Fluorescent layers 81 and 82 are formed at the upper substrate 51 exposed through the discharge hole 63 and at a sidewall of a spacer layer 75 exposed through the hole, respectively. A groove that may have a predetermined depth is formed on the upper substrate 51. The fluorescent layer 81 can be formed inside of the groove. The spacer layer 75 separates the first electrodes 61 and the second electrodes 72 from each other, e.g., by a predetermined distance, and can be used as a partition. Inert mixing gases such as He+Xe, Ne+Xe, or He+Xe+Ne are implanted in a closed discharge space in the discharge hole 63 and the spacer layer 75 as gas for forming plasma.

FIG. 6A is a schematic plan view for describing the first electrodes 61 and the first electrode lines 62 of a plasma display panel according to the second embodiment of the present invention, which can be provided by a metal sheet 60 formed, for example, of aluminum (Al), which may have a predetermined thickness.

For example, as shown in FIG. 6A, a metal sheet 60 is patterned through photolithography and etch processes to create the plurality of first electrodes 61 with a suitable arrangement and having discharge holes 63 at central regions thereof, the first electrode line 62 connecting the first electrodes 61, arranged in a first direction, and a bridge 64 connecting the first electrodes 61, arranged in a second direction.

The patterned metal sheet 60 is oxidized, forming a dielectric 65 of a metal oxide on the first electrodes 61 and the first electrode lines 62. At this time, by making widths of the first electrodes 61 and the first electrode lines 62 wider than a width of the bridges 64, and by performing an oxidizing process, when the dielectric 65 is formed, the bridges 64 are completely changed to an oxide. Here, the dielectric 65 is an oxide of the first electrode 61. Accordingly, after the bridges 64 are changed to the oxide, the first electrodes 61 connected in the second direction by the bridges 64 are structurally connected to each other, but can be electrically isolated.

FIG. 6B is a plan view illustrating a second electrode 72 and a second electrode line 73 of a plasma display panel according to a second embodiment of the present invention, which can be provided by a metal sheet 70 formed, for example, of aluminum Al, in more detail.

For example, the metal sheet 70 is patterned through photolithography and etch processes to create a plurality of second electrodes 72 with a suitable arrangement and having discharge holes 74 at central regions thereof, the second electrode lines 73 connecting the second electrodes 72 in a first direction, and bridges 75 connecting the second electrodes 72 in a second direction.

The patterned metal sheet 70 is oxidized, forming a dielectric 76 of a metal oxide on the second electrodes 72 and the second electrode lines 73 as shown in FIG. 6B. At this time, by making widths of the second electrodes 72 and the second electrode lines 73 wider than a width of the bridges 75, and by performing an oxidizing process, when the dielectric 76 is formed, the bridges 75 are completely changed to an oxide. Here, the dielectric 76 is an oxide of the second electrodes 72. Accordingly, after the bridges 75 are changed to the oxide, the second electrodes 72 connected in the second direction by the bridges 75 are structurally connected to each other, but can be electrically isolated.

The first electrodes 61 and the first electrode lines 62 formed as above from a metal sheet 60 can be adhered to the upper substrate 51 by an adhesive 56.

The embodiment above described the first electrodes 61 and the second electrodes 72 having an asymmetric construction and an annular shape. However, the present invention is not limited thereto. It can be embodied in various forms. For example, the first electrode 61 and the second electrode 72 can have a polygonal structure with a discharge hole with a circular or a tetragonal shape that is formed at a central of a tetragonal electrode. In a further embodiment, the spacer layer 75 can be a partition for isolating a pixel. Otherwise, a separate partition can be formed.

In the above and other exemplary embodiments, in order to drive the plasma display panel including first electrodes 21 or 61, and second electrodes 32 or 72 of an asymmetric construction, as shown in FIG. 7, an alternating current (AC) type first pulse and second pulse are applied to the first electrodes 21 or 61, and the second electrodes 32 or 72 of a pixel, respectively, which are selected through the first electrode lines 22 or 62, and the second electrode lines 33 or 73, respectively.

With reference to FIG. 7, the first pulse and the second pulse have the same width W1 and W2, the same period, and a phase difference that may be predetermined. That is, while a potential of the first electrodes 21 or 61 changes from a ground voltage V_{G} to a sustain voltage V_{S} and then maintains the sustain voltage value, the second electrodes 32 or 72 maintain the ground voltage V_{G}. After a potential of the first electrodes 21 or 61 changes from the sustain voltage V_{S} to the ground voltage V_{G}, a potential of the second electrodes 32 or 72 changes from the ground voltage V_{G} to the sustain voltage V_{S}. In the aforementioned manner, the first pulse and the second AC pulses are applied to alternately stack a wall charge (negative charge and positive charge) at the first electrodes 21 or 61, and the second electrodes 32 or 72, thereby maintaining a discharge.

However, as shown in FIG. 7, when the first pulse and the second pulse are applied to the first electrodes 21 or 61, and the second electrodes 32 or 72, an intensity and an amount of light be emitted can be non-uniform. This can cause a problem in expressing gray levels.

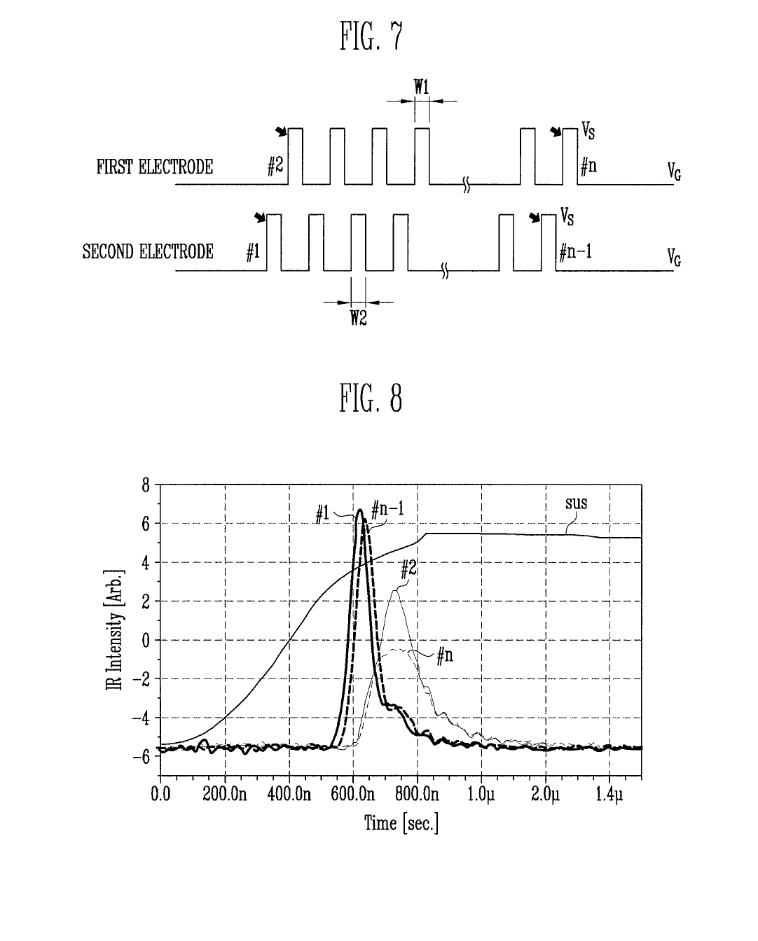

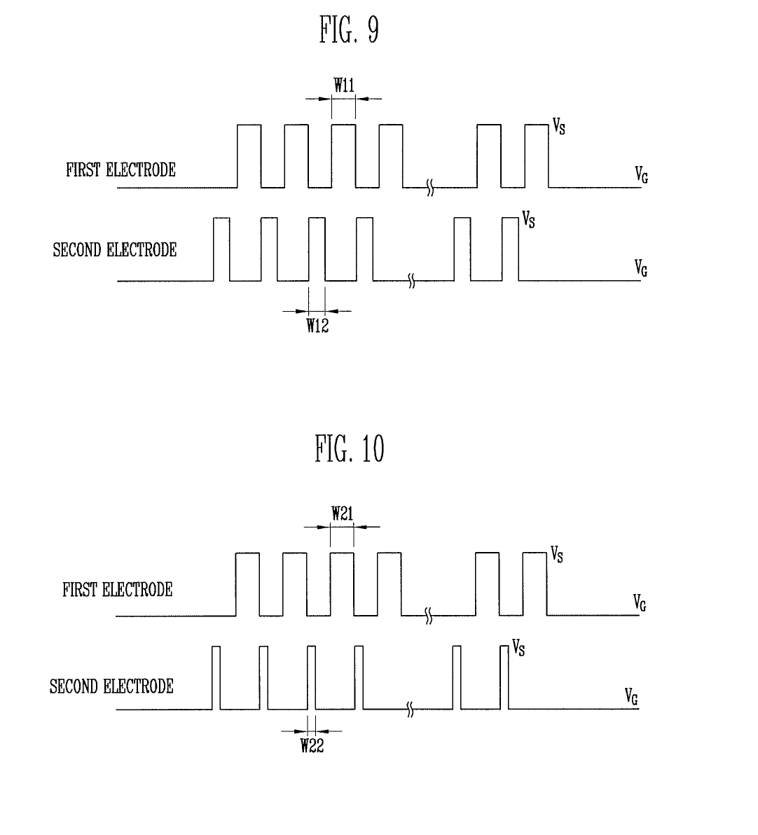

FIG. 8 is a graph that illustrates an amount of infrared rays (IR) emitted from the plasma display panel driven by the aforementioned pulses. A curved line sus corresponds to a sustain pulse, curved lines #1 and #n−1 correspond to second pulses applied to the second electrodes 32 or 72, and curved lines #2 and #n correspond to first pulses applied to the first electrodes 21 or 61.

With reference to FIG. 7 and FIG. 8, when comparing an initial pulse (curved lines #1 and #2) with a final pulse (curved line #n−1 and #n), the intensity and the amount of light corresponding to the first electrodes 21 or 61 is less than that corresponding to the second electrodes 32 or 72. Such differences in the intensity and amount of light are caused by the asymmetrical construction of the first electrodes 21 or 61, and the second electrodes 32 or 72. That is, since an area of the first electrodes 21 or 61 is greater than that of the second electrodes 32 or 72, a sufficient amount of wall charge is not formed by an electric current flowing through the first electrodes 21 or 61. This is a cause of differences in the intensity and amount of light. Problems can occur expressing an image by a difference in wall charge as mentioned above.

Accordingly, as shown in FIG. 9, an embodiment of the present invention sets a width W11 of the first pulse applied to the first electrodes 21 or 61 to be wider than a width W12 of the second pulse applied to the second electrodes 32 or 72 to store the wall charge uniformly in the first electrodes 21 or 61, and the second electrodes 32 or 72. In other words, by increasing the width W11 of the first pulse applied to the first electrodes 21 or 61 to be wider than the width W12 of the second pulse applied to the second electrodes 32 or 72, the amount of electric current flowing through the first electrodes 21 or 61 is increased. This increases the wall voltage in order to increase the intensity and amount of emitted light. According to various embodiments, a falling time of the first pulse corresponds to a rising time of the second pulse.

However, because an increase in the width W11 of the first pulse applied to the first electrodes can be limited according to a size (time) of a sustain discharge interval, as shown in FIG. 10, concurrently, the width W21 of the first pulse applied to the first electrodes can be increased, and the width W22 of the second pulse applied to the second electrodes can be reduced.

As is clear from the foregoing description, according to various exemplary embodiments of the present invention, in an alternating current type plasma display panel including a first electrode and a second electrode of an asymmetrical construction, an electrode is manufactured from a metal sheet and adhered to a substrate, so that the number of manufacturing steps is reduced and assembly is easier in comparison with a conventional plasma display panel.

Moreover, in order to drive the plasma display panel, the present invention applies a first pulse having a voltage that may be predetermined to a first electrode, and applies a second pulse to a second electrode. Here, the second pulse applied to the second electrode has a width and a phase that are different from those of the first pulse applied to the first electrode. In this case, by adjusting the width of the first pulse applied to the first electrode to be wider than that of the second pulse applied to the second electrode, or increasing the width the first pulse applied to the first electrode and relatively reducing the width of the second pulse applied to the second electrode, the pulse width can be adjusted according to the size of the electrodes. Accordingly, the amount of wall charge in two electrodes becomes substantially uniform, thereby making the intensity and an amount of the light substantially uniform.

Although exemplary embodiments of the present invention have been shown and described, it will be appreciated by those skilled in the art that changes might be made in these embodiments without departing from the principles and spirit of the invention, the scope of which is defined in the claims and their equivalents.

What is claimed is:

1. A plasma display panel comprising:
a first substrate and a second substrate that face each other;
a plurality of first electrodes between the first substrate and the second substrate, and coupled to each other in a first direction by a first electrode line, with discharge holes at central regions of the first electrodes;
a dielectric enclosing the first electrode and the first electrode line and coupling the plurality of first electrodes to each other in a second direction;
a plurality of second electrodes on the second substrate corresponding to the discharge holes, and coupled to each other in the second direction by a second electrode line; and
a fluorescent layer on the first substrate, wherein the fluorescent layer is exposed through the discharge holes.

2. The plasma display panel as claimed in claim 1, wherein the first electrode and the second electrode have a circular shape.

3. The plasma display panel as claimed in claim 1, wherein the dielectric comprises an oxide of a same material as the first electrode.

4. The plasma display panel as claimed in claim 1, wherein the dielectric is used as a partition.

5. The plasma display panel as claimed in claim 1, wherein the first electrode, the first electrode line, and the dielectric are formed from a sheet.

6. The plasma display panel as claimed in claim 1, further comprising an adhesive between the first substrate and the first electrode.

7. The plasma display panel as claimed in claim 1, further comprising a dielectric enclosing the second electrode.

8. The plasma display panel as claimed in claim 1, further comprising a spacer between the first electrode and the second substrate, the spacer having a hole corresponding to the discharge holes.

9. The plasma display panel as claimed in claim 1, wherein holes are at central regions of the second electrodes, and the plasma display panel further comprises a second dielectric enclosing the second electrode and the second electrode line and connecting the plurality of second electrodes to each other in the first direction.

10. The plasma display panel as claimed in claim 9, wherein the second dielectric comprises an oxide of the second electrode.

11. The plasma display panel as claimed in claim 9, wherein the second electrode, the second electrode line, and the second dielectric are formed from a sheet.

12. A method for driving an alternating current type plasma display panel including a first electrode and a second electrode of an asymmetrical construction, comprising:
applying a first pulse to the first electrode; and
applying a second pulse to the second electrode, the second pulse having a width and a phase different from those of the first pulse.

13. The method as claimed in claim 12, wherein the width of the first pulse is wider than the width of the second pulse.

14. The method as claimed in claim 12, wherein the width of the second pulse is narrower than the width of the first pulse.

15. The method as claimed in claim 12, wherein a falling time of the first pulse substantially corresponds to a rising time of the second pulse.

16. A plasma display panel prepared by a process comprising:
patterning a first metal sheet to form first electrodes having first discharge holes in central regions thereof, coupled in a first direction by first electrode lines, and coupled in a second direction by first bridges;
oxidizing the first metal sheet to form a dielectric enclosing the first electrodes and the first electrode lines, and to completely oxidize the first bridges;
arranging the first metal sheet between a first substrate and a second substrate;
patterning a second metal sheet to form second electrodes coupled in a third direction by second electrode lines and coupled in a fourth direction by second bridges;
oxidizing the second metal sheet to form a dielectric enclosing the second electrodes and the second electrode lines, and to completely oxidize the second bridges;
arranging the second metal sheet on the second substrate such that the first direction crosses the third direction; and
forming fluorescent regions on the first substrate corresponding to the first discharge holes.

17. The plasma display panel prepared by the process claimed in claim 16, wherein the second electrodes have second discharge holes at central regions thereof.

18. The plasma display panel prepared by the process claimed in claim 17, further comprising:
forming spacers between the first electrodes and the second electrodes, the spacers having holes corresponding to the first discharge holes.

19. The plasma display panel prepared by the process claimed in claim 18, further comprising:
forming fluorescent regions at sidewalls of the spacers corresponding to the holes.

20. The plasma display panel prepared by the process claimed in claim 16, further comprising:
forming grooves on the first substrate corresponding to the first discharge holes prior to forming the fluorescent regions on the first substrate.
